(19) United States
(12) Patent Application Publication
(10) Pub. No.: US 2013/0276518 A1
(43) Pub. Date: Oct. 24, 2013

(54) Apparatus And A Method Of Measuring Fluid Properties Using A Suspended Plate Device

(71) Applicants: NICHOLAS DAGALAKIS, Potomac, MD (US); Donald Clark Degroot, Longmont, CO (US); Roger Thomas Dirstine, Loveland, CO (US); John Melvin Olson, Boulder, CO (US)

(72) Inventors: NICHOLAS DAGALAKIS, Potomac, MD (US); Donald Clark Degroot, Longmont, CO (US); Roger Thomas Dirstine, Loveland, CO (US); John Melvin Olson, Boulder, CO (US)

(73) Assignee: ACTA TECHNOLOGY, BOULDER, CO (US)

(21) Appl. No.: 13/451,333

(22) Filed: Apr. 19, 2012

(51) Int. Cl. G01N 11/16

(52) U.S. Cl. 73/54.25

(57) ABSTRACT

An apparatus and a method of determining fluid properties by using a micro-machined suspended plate. The plate is suspended by a plurality of springs and the plate is in contact with the fluid. The power to move the plate and the phase angle between the driving frequency and the actual frequency that the plate moves changes as the plate is moved while in contact with the fluid. The device can measure clotting time, stiffness, damping ration, velocity, and viscosity of the fluid by comparison with standards.

### STATEMENT REGARDING FEDERALLY SPONSORED RESEARCH OR DEVELOPMENT

These inventions were developed under a cooperative research and development agreement (CRADA-CN-11-0019) between a small business and a Federal Research Laboratory. The Federal Laboratory is US Department of Commerce's National Institute of Standards and Technology (NIST). NIST developed a positioning stage that uses a series of levers and was granted a U.S. Pat. No. 6,467,761 B1. This patent application is subject to the CREATE ACT of 2004.

### REFERENCE TO RELATED APPLICATIONS

N/A

### BACKGROUND OF THE INVENTION

This invention covers a device and a method of measuring properties of uniform fluids and of complex fluids with greater accuracy, speed, and precision. Human body fluids are an example of complex fluids and are called by such names as: aqueous humour, vitreous humour, bile, blood, blood serum, breast milk, cerebrospinal fluid, cerumen (earwax), endolymph and perilymph, female ejaculate, gastric juice, mucus, peritoneal fluid, pleural fluid, saliva, sebum (skin oil), semen, sweat, tears, vaginal secretion, vomit and urine. This invention has the potential to provide significant improvement in the speed, accuracy, precision and cost of determining physical and mechanical properties of fluids. Such properties may include viscosity, shear rate, clotting time, stiffness, velocity, drag energy, temperature, storage modulus (elastic modulus −G′), loss modulus (viscous modulus G″), dielectric constant, resistivity, and percent of the constituents that make up the complex fluid.

This invention uses micro-electromechanical (MEMS) manufacturing techniques in its preferred embodiment. MEMS manufacturing offers competitive advantages over other devices because of its low cost, small size and low power requirements. This suspended parallel plate design offers superior accuracy, sensitivity, and stability.

This invention uses a novel way of measuring physical properties of fluids, a suspended plate that moves in contact with the fluid. This invention does not require levers as discussed in U.S. Pat. No. 6,467,761. In the preferred embodiment, the plate is suspended by a plurality of springs. These springs allow for harmonic motion. An actuator moves the suspended plate. The actuator motion causes the suspended plate to move. The dynamic equation becomes:

m\ddot{x}+c\ddot{x}+kx=F sin(ωt+φ) Eq. [1]

In equation 1 above: m=mass, c=total damping, k=total stiffness, \ddot{x}=acceleration of plate, \ddot{x}=velocity of the plate, x=amplitude of the motion of the plate, F is the force from the actuator (driving force), ω=the frequency of the driving force, t=time and finally φ=the phase shift between the driving force and the natural frequency.

The natural frequency (fₙ) of the system is shown in equation 2 below:

$${f}_{n} = \frac{1}{2 π} \sqrt{\frac{k}{m}} \qquad Eq . [ 2 ]$$

From the above two equations the properties of the fluids are determined. It is well known in the art how to solve equations 1 and 2. These equations become the bases for determining the properties of the fluids.

### BRIEF SUMMARY OF THE INVENTION

This invention allows a suspended plate to move parallel to a surface without crosstalk or the Abbe effect. The Abbe effect is a well known error in precision electronics caused by sensor placement resulting in displacement errors. The suspended plate moves parallel to a surface. The plate may be over the fluid and in contact with fluid, under the fluid and in contact with the fluid or in the fluid. The plate is suspended by springs and an actuator moves the plate. The fluid is in contact with the plate. The actuator can be a thermo-actuator, electric motor or piezoelectric actuator. This invention also includes a method of determining the properties of the fluid.

For viscosity properties, the suspended plate is moved by the actuator using a sinusoidal, square wave or other known wave form. The viscosity is determined by the power that is needed to move the plate. This is novel because other MEMs viscometers use cantilevers, cone and plate, or time to empty a known volume. Other viscometers require a sensor on the device. This design requires only the measurement of the power to determine the energy going to the actuator. If the viscosity of the fluid increases the power required to translate the plate back and forth also increases. Similarly if the viscosity of the fluid in contact with the plate decreases the power to move the plate also decreases. It is this correlation between power and viscosity that enables the device to determine the viscosity of the fluid. The power to move known fluids with known viscosities is first determined thereby rendering a viscosity versus power database. Displacement sensors may also be used. The sensor may be of any suitable design, for example a capacitor or optical type. For optical type, the phase change from the forcing frequency and the actual frequency will give you the drag energy. This drag energy is proportional to viscosity. For displacement sensors, the coefficient of damping (C) in equation 1 is proportional to viscosity and can be determined once the amplitude of the motion is known.

For shear rate properties, the suspended plate is moved by the actuator using a sinusoidal, square wave or other known wave form where the plate in contact with the fluid is over, under or in the fluid. The shear rate is proportional to the rate of increase or decrease in the power that is needed to move the plate. The device is powered at different frequencies and the different viscosities are again determined. For example if the complex fluid is shear thinning, the power to move the plate will decrease as the frequency of the plate is increased.

For temperature readings, the suspended plate is moved by the actuator again using a sinusoidal, square wave or other known wave form where the fluid in contact with the plate is over, under or in the fluid. The fluid's viscous properties are known as a function of temperature. Since viscosity is a function of temperature one skilled in the art can establish a correlation between power to move the suspended plate and temperature. For example, if the temperature is increased, the viscosity will decrease and the power to move the plate is also decreased. If the temperature is decreased the viscosity will increase and the power to move the plate also increases.

For clotting time of human blood or other complex fluids, the suspended plate in contact with the fluid is moved by the actuator again using a sinusoidal, square wave or other wave form. As the blood clots the viscosity of the blood increases with time. As a result the power to move the plate and drag energy also increases. The change in power is measured; thereby the clotting rate of the blood can be determined. The phase angle between the driving frequency and frequency of the moving plate can also give you the rate of change in drag energy which is proportional to clotting rate. Drag energy is the amount of energy consumed by the suspended plate due to contact with the fluid during movement. Finally displacement sensors can be used as well. For example, the displacement of the suspended plate will be less as the viscosity of the blood increases. The rate of reduction in displacement is a function of the clotting time rate.

For flow velocity readings, the suspended plate in contact with a flowing fluid is moved by the actuator using a sinusoidal, square wave form or other known wave form. The drag energy increases as the power increases to move the suspended plate if the velocity of the fluid is in the opposite direction of the direction of movement of the suspended plate. Therefore, the change in energy required to move the suspended plate is a function of the velocity of the fluid. For example if the fluid is not moving, the power to move the suspended plate in one direction is the same as the power to move the suspended plate in the opposite direction. If the fluid is moving from left to right, the power to move the suspended plate from left to right is less than the power to move the suspended plate from right to left. It is this difference in the power consumed by the actuator that is proportional to the velocity of the fluid.

For the dielectric property of the fluid, a capacitor or set of capacitors are used. The capacitor has a plurality of flat plates. A flat plate is located ether above or below the suspended plate. Any conductive material is deposited onto the surface of the suspended plate and onto the surface of a stationary surface or plate above or below the suspended plate. The stationary surface or plate will be separated from the moving suspended plate by the fluid at a distance d. The capacitance is a function of the dielectric constant of the fluid, the distance d, and the plate's average area A. The suspended plate does not have to be moved. In the preferred embodiment, the moving plate has one conductive surface deposited on the moving suspended plate and a conductive material deposited on the stationary plate or surface. The stationary plate or surface can have two or more conductive surfaces. For example, the capacitance of a parallel-plate capacitor constructed of two parallel plates both of area A separated by a distance d is approximately equal to the following:

$$C = {ɛ}_{r} {ɛ}_{0} \frac{A}{d} \qquad Eq . 3$$

### Where:

C is the capacitance;
A is the area of overlap of the two plates;
∈ᵣ is the relative static permittivity (sometimes called the dielectric constant) of the material between the plates (for a vacuum, ∈ᵣ=1);
∈₀ is the electric constant (∈₀≈8.854×10⁻¹² F m⁻¹) and
d is the separation between the plates.

Methods of determining capacitance are well known in the art. The dielectric property of the fluid can be determined once the capacitance is measured.

For resistivity properties of the fluid, a structure similar to that of the capacitor, or set of capacitors discussed above are again used. An electric field inside the device is created in the fluid between the conductive plates. A potential between the plates is used to determine resistivity. The potential difference will cause a current to flow. The electrical resistivity (ρ) is defined as the ratio of the electric field to the current it creates:

$$ρ = \frac{E}{J} \qquad Eq . 4$$

where

ρ is the resistivity of the conductor material (measured in ohm·meter, Ω·m),

E is the magnitude of the electric field (in volts per meter, V·m⁻¹),

J is the magnitude of the current density (in amperes per square meter, A·m⁻²).

Conductivity of the fluid is the inverse of resistivity and can be calculated.

For storage modulus (elastic modulus −G′), loss modulus (viscous modulus G″), and total stiffness, the suspended plate in contact with the liquid is moved by the actuator using a sinusoidal, square wave or other known wave form. The displacement of the suspended plate is determined. Equation 1 is used to determine the fluid properties. At least three difference driving frequencies are used to determine the unknown variables. With the driving frequencies and displacement of the plate known, the displacement, velocity and acceleration can be determined as a function of time. One skilled in the art of controls knows how to determine the stiffness, damping ratio, storage modulus, and loss modulus from equation 1 above.

For percent of the constituents that compose the complex fluid, the suspended plate in contact with the fluid is moved by the actuator using a sinusoidal, square wave or known wave form. The displacement of the suspended plate is determined and equation 1 is used to find total stiffness. The stiffness of each constituent that makes up the complex material is then calculated by first determining the displacement at numerous frequencies. In equation 1 the stiffness is the total stiffness of the device plus the stiffness of the fluid. With complex fluids the stiffness of the fluid is the sum of all the stiffness's of the constituents that makeup the complex fluid.

$$\frac{1}{{k}_{total}} = \frac{1}{{k}_{1}} + \frac{1}{{k}_{2}} + … \frac{1}{{k}_{N}} \qquad Eq . 5$$

where kₜₒₜₐₗ₌is the total stiffness and k_{N} is the stiffness of each constitutent. As an example, for a complex fluid with three constituents that make up the complex fluid, at least five different driving frequencies are used. Since the driving frequencies are known, the displacement, velocity and acceleration are determined as a function of time from equation 1. One skilled in the art of controls knows how to determine the total stiffness and the damping ratio. Equations 1 and 5 are used to determine the percent of each constituent because the stiffness of each constituent is known and the total stiffness is also known. One skilled in the art knows how to solve for the unknowns in equations 1 and 5.

For mass sensing, an absorbent is deposited onto the moving suspended plate. The moving suspended plate is moved by the actuator using a sinusoidal, square wave or known wave form. The driving frequency is known and the power to move the suspended plate is determined. As mass collects on the absorbent, the energy to move the suspended plate is increased. The energy increase is proportional to the mass collected by the absorbent. Changes in natural frequency (equation 2) can also be used to determine the change in mass collected by the absorbent. The current required to drive the device decreases at resonance. A current sensor can be used to determine the shift in natural frequency which is proportional to the mass collected by the device.

### DESCRIPTION OF THE DRAWING

FIG. 1—Depicts a parallel plate MEMS device.

FIG. 2—Depicts a vertical plate device

FIGS. 3A and 3B—Depicts the Spring Design for Resonance

FIG. 4—Depicts the power measurements

FIGS. 5A and 5B—Depicts capacitance measurements

FIG. 6—Depicts input and output variables for the processor

FIG. 6A—Depicts the method of determining the natural frequency

FIG. 6B—Depicts the method of determining the drag energy

FIG. 6C—Depicts the method of determining the viscosity

FIG. 6D—Depicts the method of determining the clotting time

FIG. 6E—Depicts the method of determining the mass absorbed

FIG. 6F—Depicts the method of determining the shear rate of the fluid

FIG. 6G—Depicts the method of determining the velocity, acceleration and displacement of the plate

FIG. 6H—Depicts the method of determining the stiffness, storage modulus and loss modulus

FIG. 6I—Depicts the method of using an optical sensor to determine the velocity, acceleration and displacement

FIG. 7—Depicts blood clotting versus time

FIG. 8—Depicts natural frequency shift when mass is collected on the plate

FIG. 9—Depicts shear thinning versus frequency

FIG. 10—Depicts phase shift versus mass collected on plate

### DETAILED DESCRIPTION OF THE INVENTION

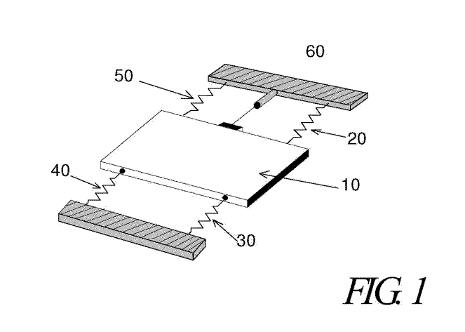

FIG. 1 illustrates a parallel suspended plate device for testing fluids. The suspended plate 10 can be designed to move vertically, horizontally or in any other orientation. In the preferred embodiment the suspended plate moves horizontally. A plurality of springs 20, 30, 40, 50 suspend the plate. An actuator 60 moves the plate in a known wave form fashion. The invention is a new type of MEMS device that measures the physical properties of fluids. It measures properties of the fluids in contact with the upper, lower or both upper and lower surfaces of the suspended plate 10. The power to oscillate the actuator 60 is measured or is known. The actuator 60 may be a thermal, piezoelectric or motor driven type. The fluid will cause the drag energy to increase. The drag energy will cause the power to move the suspended plate to increase. The increased power is proportional to the viscosity of the fluid.

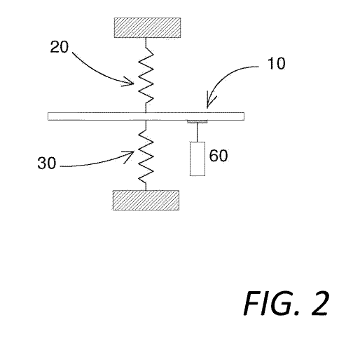

As depicted in FIG. 2, the MEMS device uses a suspended plate 10. An actuator 60 moves the plate up and down. The actuator 60 is connected to a push rod. A plurality of springs 20, 30 suspended the plate 10.

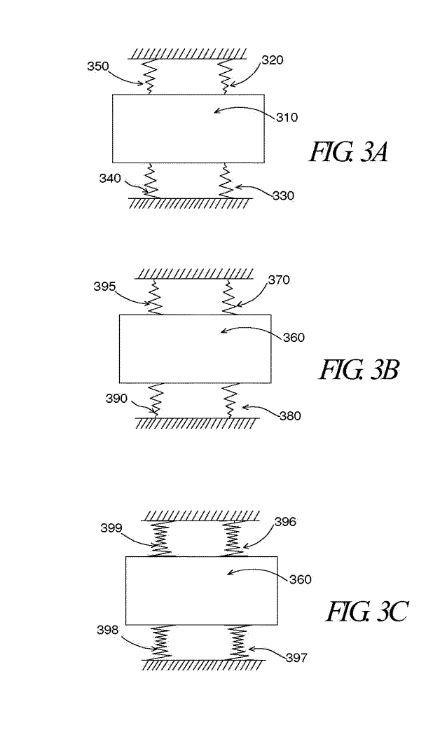

FIGS. 3A, 3B and 3C illustrates the spring design 320, 350, 330, 340, 395, 370, 380, 390, 399, 396, 398, 397 when resonance is used to determine the stiffness, mass accumulated on the plate or viscosity of the fluid. The geometry of the spring 320, 350, 330, 340 or 395, 370, 380, 390 or 399, 396, 398, 397 is changed so that the stiffness of the spring is variable and not a constant. The spring has a higher stiffness at or near resonance. This new design helps reduce the displacement of the plate at resonance. The springs can be a bellows design.

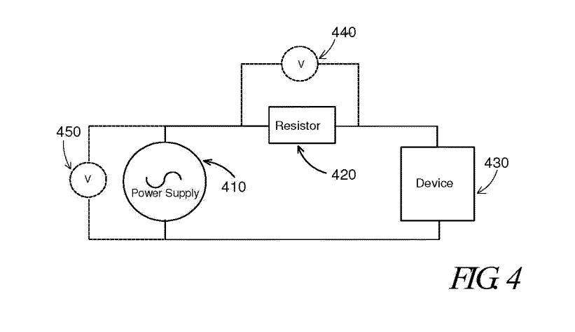

FIG. 4 details the method of measuring the power that the MEMS device 430 uses. An increase in viscosity, velocity or clotting will cause an increase in drag energy. The device is powered with a known voltage 450 and frequency 410. A high precision resistor 420 is placed in series with the device 430. The voltage 440 across the resistor 420 is determined. This voltage 440 is proportional to the current flowing to the device 430. An increase in drag energy will cause an increase in current through the resistor 420 and can be observed by the voltage increase across the resistor 440. Therefore by knowing the voltage 440, the fluid drag energy, viscosity, velocity, stiffness or clotting time of the fluid can be determined.

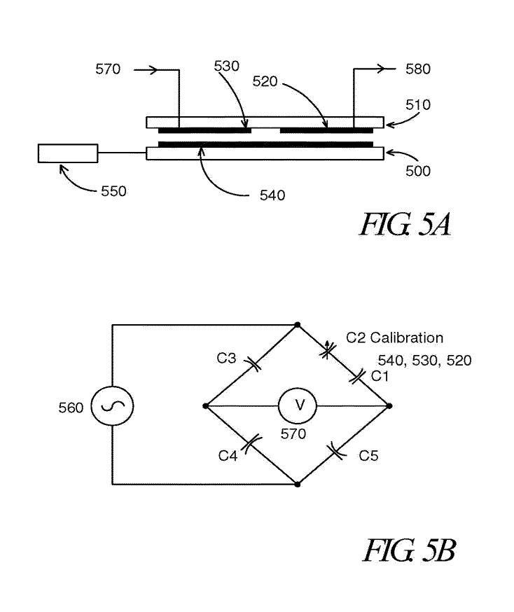

FIGS. 5A and 5B illustrate the method for determining the displacement, velocity and acceleration of the suspended plate 500 using capacitance. A conductive layer 540, a substance like chrome is applied to the surface and then gold, is placed down on the moving suspended plate 500. Other conductive materials can be used. The actuator 550 moves the conductive suspended plate parallel to two other conductive plates 530 and 520. An AC current supply 570 is attached to the first plate 530. The current flows through the fluid space to the moving suspended plate's conductive layer 540. The current then flows back to a second conductive plate 520 back to the current source 580. The oscillation of the plate causes the capacitance to change because the overlap of the plates 530, 520, 540 changes. The leads 580, 570 are connected to a Wheatstone bridge that that is powered by an AC current. Capacitor C4 and C5 are equal. Capacitor C3 equals the sum of C1 plus C2. C2 is for calibration and for zeroing the bridge. C2 is an adjustable capacitor. The voltage 570 across the bridge is proportional to the change is displacement of the plate 500.

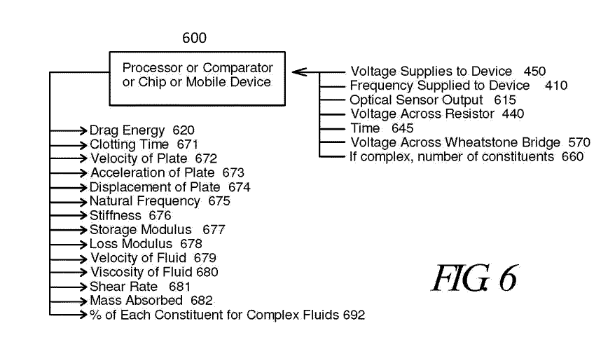

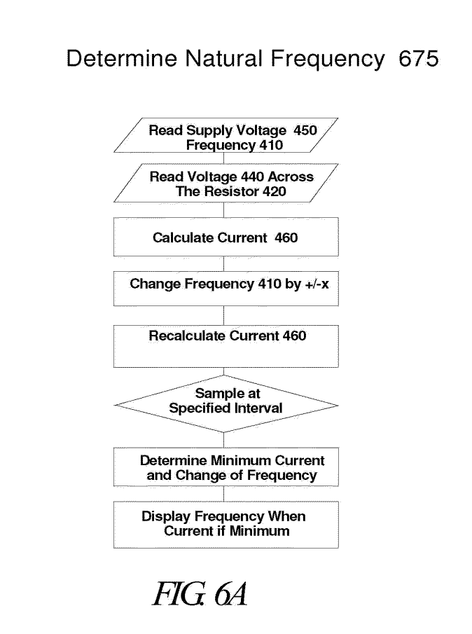

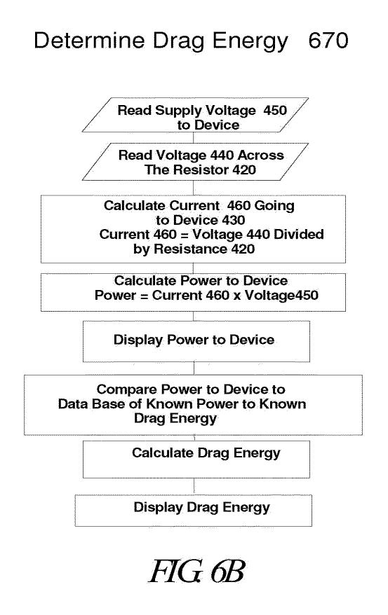

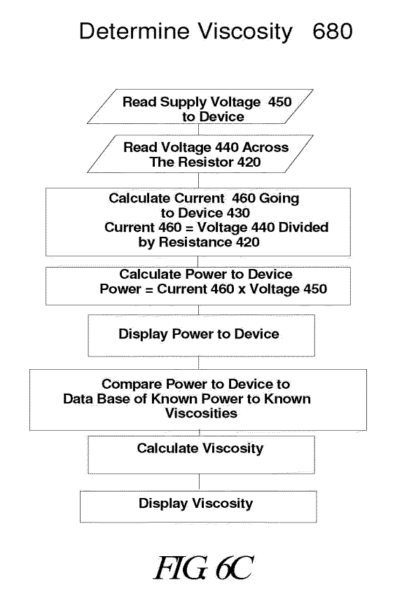

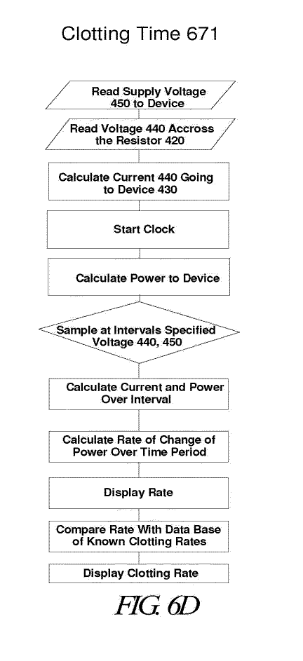

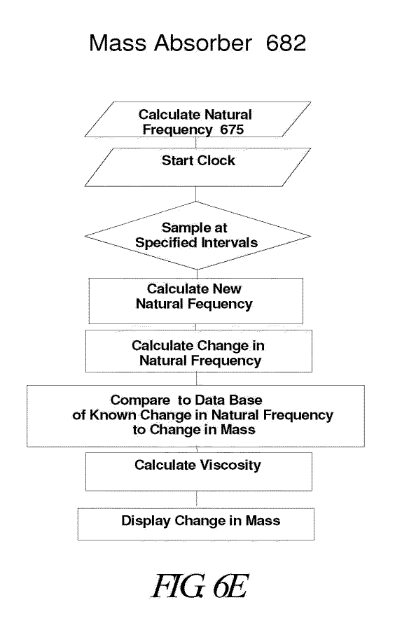

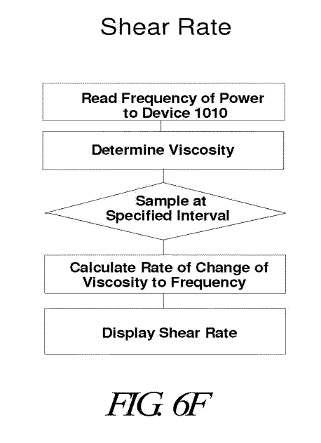

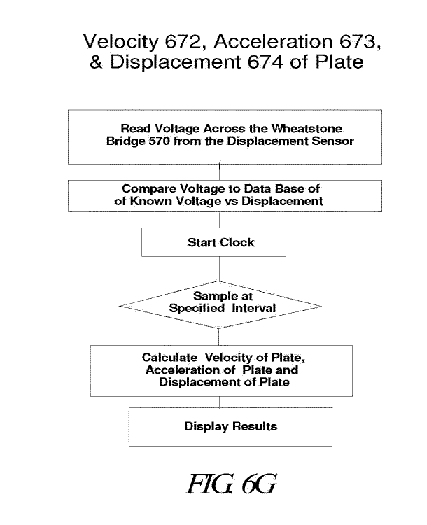

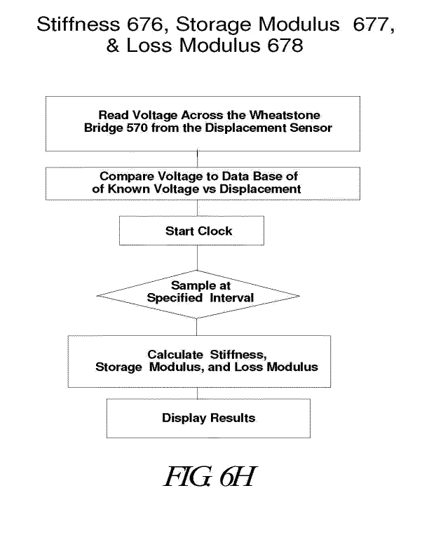

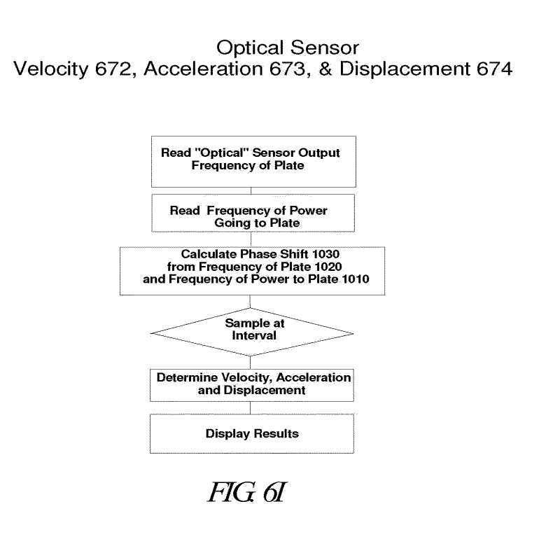

FIG. 6 shows the input and output variables for the device. A microprocessor chip 600 is used to control the device. The microprocessor can be any form of processor including a computer, microprocessor, tablet, mobile device or an electronic circuit that can calculate equations, take inputs and produce an output signal. The voltage supply to the device is measured 450. The frequency at which the plate is to be moved is an input variable 410. The voltage 570 across the resistor 440 is an input variable to the microprocessor 600. If an optical sensor is used, then the frequency of the suspended plate actual movement is an input variable 615. Time 645 is another input variable when shear rates and clotting time are the outputs. If capacitor sensors 520, 530, 540 are used to determine displacement of the plate, the voltage drop across the Wheatstone bridge 570 is an input variable. For complex fluids; the number of constituents that are part of the complex fluid and the stiffness of each constituent is an input variable 660. The possible output signals of the microprocessor are drag energy 620, clotting time 671, velocity of the fluid 679, velocity of the plate 672, acceleration of the plate 673, displacement of the plate 674, natural frequency of the plate 675, stiffness of the system 676, storage modulus, 677, loss modulus 678, velocity of the plate 672, viscosity of the fluid 680, shear rate 681, percent of each constituent for complex fluids 692, and mass absorbed 682.

FIG. 6A depicts the method of determining the natural frequency 675. FIG. 6B depicts the method of determining the drag energy 670. FIG. 6C depicts the method of determining the viscosity of the fluid 680. FIG. 6D depicts the method of determining the clotting time of complex fluids like human blood 671. FIG. 6E depicts the method of determining the mass absorbed on the suspended plate 682. FIG. 6F depicts the method of determining the shear rate of the fluid 681. FIG. 6G depicts a method of determining the velocity 672, acceleration 673 and displacement 674 of the plate. FIG. 6H depicts the method of determining the stiffness 676, storage modulus 677, and loss modulus 678. FIG. 6I depicts the method of determining the velocity 672, acceleration 673, and displacement 674 of the plate using an optical sensor.

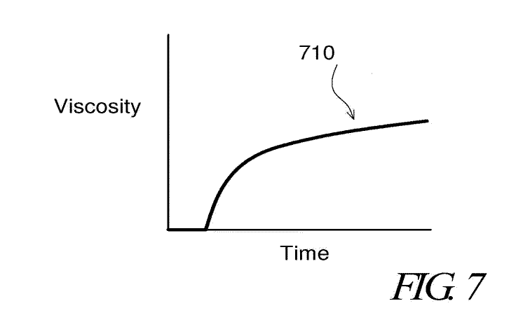

FIG. 7 depicts viscosity versus time for blood clotting 710. When blood starts to clot, the viscosity of the blood also increases. This causes the drag energy to increase. The microprocessor 600 is able to detect increases in current going to the actuator 60. This increase is proportional to the drag energy and viscosity increase. In order to calculate clotting time 671, time differences are recorded and used by the microprocessor to determine clotting rate. As the blood clots the volume of the blood also increases. If a capacitor 530, 520, 540 is used the distance between the plates is increased. This increase in capacitance is proportional to the rate of blood clotting. As the blood clots and it's volume increases, the space between the capacitor plates also increases thereby producing a decrease in capacitance. The Wheatstone bridge voltage 570 will give a signal proportional to the blood clotting rate.

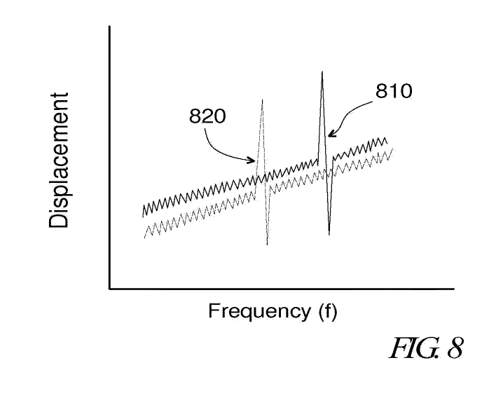

FIG. 8 illustrates the natural frequency 810 of the parallel plate. In one embodiment of the invention with dimensions of 2856 um (micros)×1980 um×30 um the resonance frequency 810 is approximately 6.5 kHz. When the device is being used as a mass sensor, as the mass is collected on the moving suspended plate 10 the natural frequency 810 is reduced to 820. The maximum amplitude is also reduced and the power to drive the suspended plate is increased. The microprocessor 600 monitors and records the voltage 440 across the resistor 420. When the voltage drop is at a minimum, resonance has been achieved. The driving frequency of the plate is reduced in a stepwise manner by the microprocessor 600. The microprocessor 600 determines resonance by measuring the power needed to drive the device. At resonance, the power (voltage across the resistor 440) is minimal. It is this change in natural frequency that corresponds to change in mass being collected on the device.

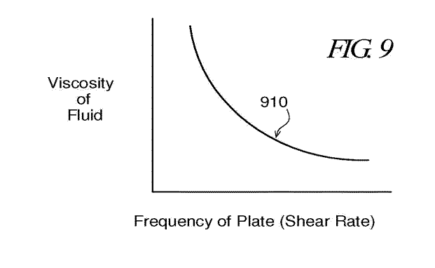

FIG. 9 illustrates the property of shear thinning that occurs in certain complex fluids. For the same temperature the viscosity of the fluid is reduced as the driving frequency of the suspended plate is increased 910. The microprocessor 600 monitors and records the voltage 440 across the resistor 420. The drag energy is proportional to the viscosity and viscosity is proportional to power required to drive the actuator 60. The voltage 440 increases as the drag energy and viscosity increase. Multiple driving frequencies supplied to the plate are used to determine the rate of shear thinning for complex fluids.

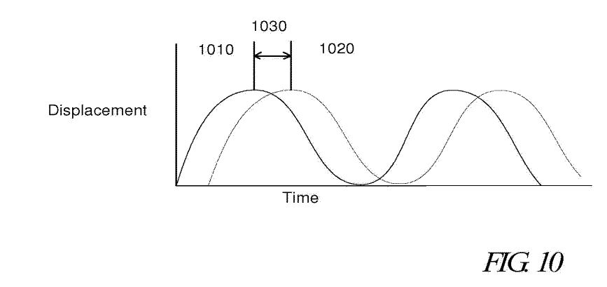

FIG. 10 details the phase shift that occurs when mass is collected on the suspended plate 10. The microprocessor 600 determines the driving frequency 1010 of the actuator 60. Because mass is collected by the thin film on the suspended plate; the frequency 1020 of the moving plate will not be the same as the original frequency 1010. There will be a phase shift 1030. The greater the phase shift 1030 the more the mass collected by the thin film.

The phase shift 1030 between the actual frequency 1020 of the suspended plate 10 and the frequency 1030 supplied to the actuator 60 is caused by drag energy or viscosity change of the fluid.

What is claimed is:

1. A method of measuring physical properties of a liquid comprising the steps of;
oscillating a suspended plate by an actuator, said plate is suspended by springs,
monitor and record the power that is needed to drive the said actuator; then put said plate in contact with the fluid, and then
monitor and record the power that is needed to drive the said actuator, when the said plate is in contact with the fluid; determine the power change; the said power change is proportional to the drag energy which is proportional to the viscosity of the fluid.

2. The method of claim 1, wherein the rate of change of power of the said actuator to oscillate the said plate versus time is determined so that clotting time of a complex fluid like human blood can be determined.

3. The method of claim 1, wherein the velocity of the fluid is determined by calculating the difference in power to oscillate the said suspended plate by said actuator when the fluid is moving in the same direct as the said plate and in the opposite direction as to the movement of said plate; the power difference when the said plate is moving in the same direction as the fluid minus the power when the fluid is moving in the opposite direction is proportional to the fluid's velocity.

4. The method of claim 1, wherein the temperature of a fluid is calculated by determining the drag energy which is a function of temperature of a known fluid such as an oil or water.

5. The method of claim 1, wherein the shear rate of a fluid is calculated by determining the drag energy at different driving frequencies of said actuator; the shear rate is a function of drag energy versus frequency.

6. A method of measuring physical properties of a liquid comprising the steps of;
oscillating a suspended plate by an actuator, said plate is suspended by springs and the said plate is in contact with a fluid;
a displacement sensor measures the displacement of the said plate;
the frequency of the power being supplied to the said actuator is known; the velocity and acceleration of said plate is then calculated at least three different frequencies; the displacement at these said different frequencies are determined; the said displacement is a function of the stiffness of the fluid, loss modulus and storage modules of the fluid and are calculated by a processor.

7. The method of claim 6, wherein an optical sensor and not a displacement sensor is used to determine the actual frequency of the said plate; the phase angle between the said actual frequency and the said frequency supplied to said actuator is then determined; the drag energy and viscosity are proportional to the said phase shift.

8. The method of claim 6, wherein the displacement, velocity and acceleration of said plate is calculated for at least n+2 number of constituents that make up the complex fluid; the total stiffness and damping ration of the complex fluid are calculated; the stiffness of each component of the said complex fluid is known; the percent of each component of the said complex fluid is then calculated.

9. A method of measuring dielectric properties of a liquid comprising the steps of;
Two parallel plates have at least one conductive surface of each of the said plates; a fluid is between the said two conductive surfaces; a current is passed through the first plate through the fluid onto the said second plate; the dielectric properties and resistivity of the fluid are then calculated.

10. A method of measuring displacement of a moving suspended plate comprising the steps of;
oscillating a suspended plate by an actuator, said plate is suspended by springs, the said plate is in contact with the fluid;
a displacement sensor measures the displacement of the said plate; the frequency of the power being supplied to the said actuator is known; the velocity and acceleration of said plate is then calculated at a minimum of three different frequencies; the displacement at each of these said different frequencies is determined; the said displacement is a function of the stiffness of the fluid, loss modulus and storage modules of the fluid and can be calculated by a processor.

11. An apparatus to detect properties of fluids comprising; a movable plate suspended by springs; the said plate is in contact with the fluid; said plate is above, below or in the fluid and an actuator moves the said plate.

12. An apparatus to measure clotting time of fluids comprising; a plate suspended by springs; the plate has a conductive layer on said plate; a stationary plate or surface is above or below said suspended plate; the said stationary plate or surface also has a conductive layer and is spaces a distance above or below said suspended plate; capacitance is measured across the said conductive surfaces; as the flood clots the distance between the plates increases.
